(19) United States
(12) Patent Application Publication
(10) Pub. No.: US 2008/0260215 A1
(43) Pub. Date: Oct. 23, 2008

(54) Fingerprint identification system

(75) Inventors: Kai-Wen Tien, Tainan City (TW); Ching-Hwa Yang, Taipei County (TW)

Correspondence Address: REED SMITH LLP, 3110 Fairview Park Drive, Suite 1400, Falls Church, VA, 22042, US

(73) Assignee: Quanta Computer Inc.

(21) Appl. No.: 11/979,509

(22) Filed: Nov. 5, 2007

(30) Foreign Application Priority Data
Apr. 18, 2007 (TW) 096206176

(51) Int. Cl. H04L 9/00; G06K 9/00

(52) U.S. Cl. 382/124; 713/150

(57) ABSTRACT

The invention discloses a fingerprint identification system including a communication network, a finger-scanning device and a server. The finger-scanning device includes a fingerprint sensor and a transmitting module. The fingerprint sensor is used for scanning a fingerprint, so as to generate a plurality of fingerprint image sections. The transmitting module is used for transmitting each of the fingerprint image sections through the communication network instantly when the fingerprint image section is generated. The server is used for receiving the fingerprint image sections from the communication network, reproducing the fingerprint, and performing identification according to the fingerprint.

### BACKGROUND OF THE INVENTION

1. Field of the Invention

The present invention relates generally to a fingerprint identification system, and more particularly, to a fingerprint identification system which can transmit or receive fingerprint image sections through communication network instantly, reproduce the fingerprint, and perform identification according to the fingerprint.

2. Description of the Prior Art

Biometrics refers to the identification performed based on the unique physical characteristics of human beings. Fingerprint identification is one of the most popular applications of biometrics. In the prior art, fingerprint identification mainly includes the following steps of: scanning the fingerprint by a fingerprint sensor and generating a fingerprint image, extracting and analyzing the characteristics of the fingerprint from the image by an identification software to confirm the identity of the fingerprint owner. Recently, fingerprint identification has been applied in several fields, such as guarded entrance control, crime-prevention, control over the use of electronic device, and identity-check during financial transaction, etc.

Fingerprint should be carefully protected because it is an important personal identity data. However, when the fingerprint-related data is transmitted through a communication network, it may be intercepted or stolen, and be subsequently used in a crime.

Therefore, the major aspect of the present invention is to provide a fingerprint identification system to solve the above-mentioned problem.

### SUMMARY OF THE INVENTION

Accordingly, one aspect of the present invention is to provide a fingerprint identification system. The fingerprint identification system of the invention applies a transmitting module to transmit and receive fingerprint image sections through a communication network. Furthermore, the fingerprint identification system can then reproduce the fingerprint and perform identification according to the fingerprint.

According to the first preferred embodiment of the invention, the fingerprint identification system includes a communication network, a finger-scanning device, and a server. The finger-scanning device can optionally be a disk-provided device or a diskless device. The finger-scanning device includes a fingerprint sensor and a transmitting module. The fingerprint sensor is used to scan a fingerprint, so as to generate a plurality of fingerprint image sections. The transmitting module is used to transmit the fingerprint image sections through the communication network instantly when each of the fingerprint image sections is generated. Additionally, the server is applied for receiving the fingerprint image sections from the communication network, reproducing the fingerprint, and performing identification according to the fingerprint.

According to the second preferred embodiment of the invention, the fingerprint identification system includes a communication network, a finger-scanning device, and a server. The finger-scanning device can optionally be a disk-provided device or a diskless device. The finger-scanning device includes a fingerprint sensor, a processing module, and a transmitting module. The fingerprint sensor is used to scan a fingerprint, so as to generate a plurality of fingerprint image sections. The processing module is used to divide each of the fingerprint image sections into a plurality of fingerprint image sub-sections. The transmitting module is used to transmit the fingerprint image sub-sections through the communication network. In addition, the server is used to receive the fingerprint image sub-sections from the communication network, reproduce the fingerprint, and perform identification according to the fingerprint.

According to the third preferred embodiment of the invention, the fingerprint identification system includes a communication network, a finger-scanning device, and a server. The finger-scanning device can optionally be a disk-provided device or a diskless device. The finger-scanning device includes a detecting area, a plurality of light sources, a fingerprint sensor and a transmitting module. The detecting area has a plurality of sub-detecting areas, whereas each of the light sources emits a light to one of the sub-detecting areas. The fingerprint sensor can scan a fingerprint passing the detecting area, so as to generate a plurality of fingerprint image sections corresponding to the plurality of sub-detecting areas. The transmitting module is used to transmit the fingerprint image sections through the communication network. Additionally, the server is applied for receiving the fingerprint image sections from the communication network, reproducing the fingerprint, and performing identification according to the fingerprint.

According to the fourth preferred embodiment of the invention, the fingerprint identification system includes a communication network, a finger-scanning device, and a server. The finger-scanning device can optionally be a disk-provided device or a diskless device. The finger-scanning device includes a detecting area, a light source, a fingerprint sensor and a transmitting module. The detecting area has a plurality of sub-detecting areas. The light source is rotatably disposed in the finger-scanning device for emitting a light to one of the sub-detecting areas. When a fingerprint passes the detecting area, the fingerprint sensor scans the fingerprint by the light, so as to generate a plurality of fingerprint image sections corresponding to the plurality of sub-detecting areas. The transmitting module is used to transmit the fingerprint image sections through the communication network. Furthermore, the server is applied for receiving the fingerprint image sections from the communication network, reproducing the fingerprint, and performing identification according to the fingerprint.

Accordingly, the fingerprint identification system of the invention can apply the transmitting module to transmit and receive the fingerprint image sections through the communication network, reproduce the fingerprint, and perform identification according to the fingerprint. During the transmission, an invader may intercept some of the fingerprint image sections A complete or identical fingerprint can not be reproduced by part of the fingerprint image sections, thus, if an invader intercepts some of the fingerprint image sections it is highly impossible for the invader to pass the identification process. Therefore, the transmission of data of fingerprint will be safer than before.

The objective of the present invention will no doubt become obvious to those of ordinary skill in the art after reading the following detailed description of the preferred embodiment, which is illustrated in the various figures and drawings.

### BRIEF DESCRIPTION OF THE APPENDED DRAWINGS

FIG. 1 is a functional block diagram of a fingerprint identification system of a preferred embodiment of the invention.

FIG. 2 illustrates a fingerprint and related fingerprint image sections.

FIG. 3 shows a functional block diagram of a fingerprint identification system of another preferred embodiment of the invention.

FIG. 4 illustrates a fingerprint, related fingerprint image sections, and related fingerprint image sub-sections.

FIG. 5 shows a functional block diagram of a fingerprint identification system of another preferred embodiment of the invention.

FIG. 6 illustrates the detecting area, the light source, and the fingerprint sensor in FIG. 5.

FIG. 7 illustrates a fingerprint and related fingerprint image sections.

FIG. 8 shows a functional block diagram of a fingerprint identification system of another preferred embodiment of the invention.

FIG. 9 illustrates the detecting area, the light source, and the fingerprint sensor in FIG. 8.

### DETAILED DESCRIPTION OF THE INVENTION

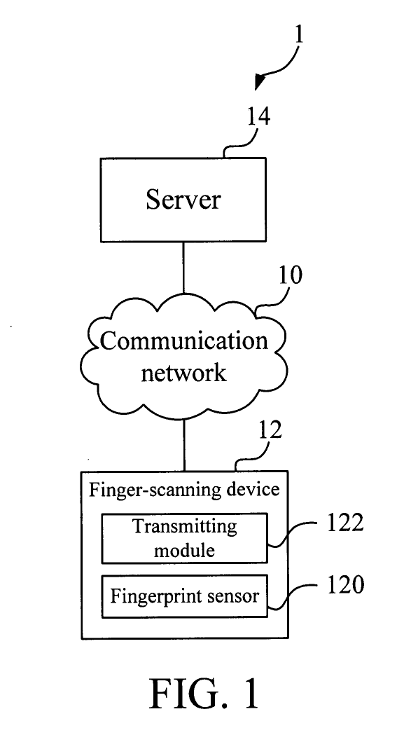

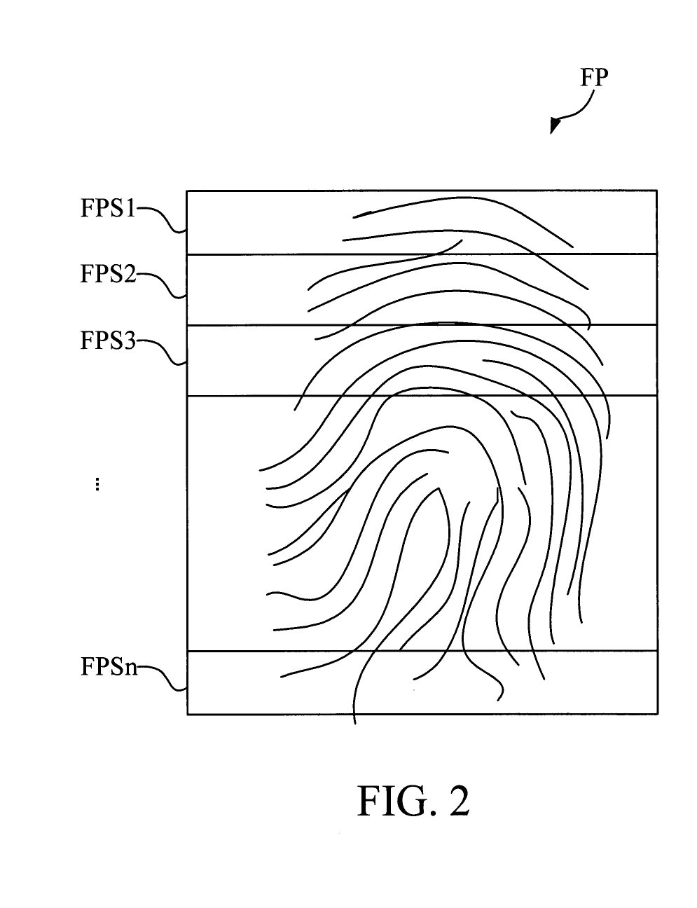

Please refer to FIG. 1 and FIG. 2. FIG. 1 is a functional block diagram of a fingerprint identification system 1 of a preferred embodiment of the invention. FIG. 2 illustrates the fingerprint FP and related fingerprint image sections FPS1-FPSn. In the embodiment, the fingerprint identification system 1 of the invention is applied for performing identification according to the fingerprint FP. As shown in FIG. 1, the fingerprint identification system 1 includes a communication network 10, finger-scanning device 12, and a server 14. The finger-scanning device 12 can optionally be a disk-provided device or a diskless device. The finger-scanning device 12 further includes a fingerprint sensor 120 and a transmitting module 122. The fingerprint sensor 120 is used to scan the fingerprint FP, and generate a plurality of fingerprint image sections FPS1-FPSn. The transmitting module 122 is used to transmit the fingerprint image sections FPS1-FPSn through the communication network 10 instantly when each of the fingerprint image sections FPS1-FPSn is generated. Furthermore, the server 14 is used to receive the fingerprint image sections FPS1-FPSn from the communication network 10, reproduce the fingerprint FP, and then performs identification according to the fingerprint FP. In practice, the transmitting module 122 can encrypt the fingerprint image sections FPS1-FPSn with a specific encryption, to increase the safety in the transmission of the fingerprint image sections FPS1-FPSn.

In the embodiment, the communication network 10 can be, but not limited to, a local area network, an intranet, an internet, a radio telecommunication network, or a public switched telephone network.

In the embodiment, during the transmission, an interception of part of the fingerprint image sections FPS1-FPSn will not reproduce a complete or identical fingerprint FP, so that an invader can't pass the identification process via the server 14. Therefore, the transmission of the data of a fingerprint will be safer than before.

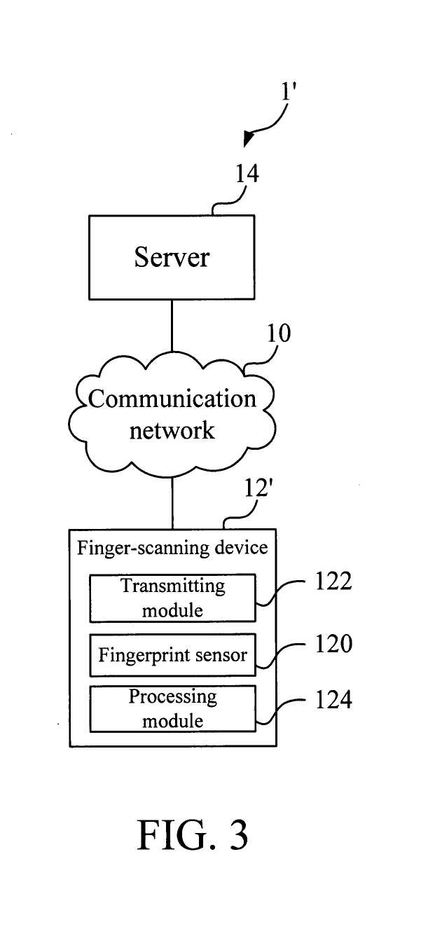

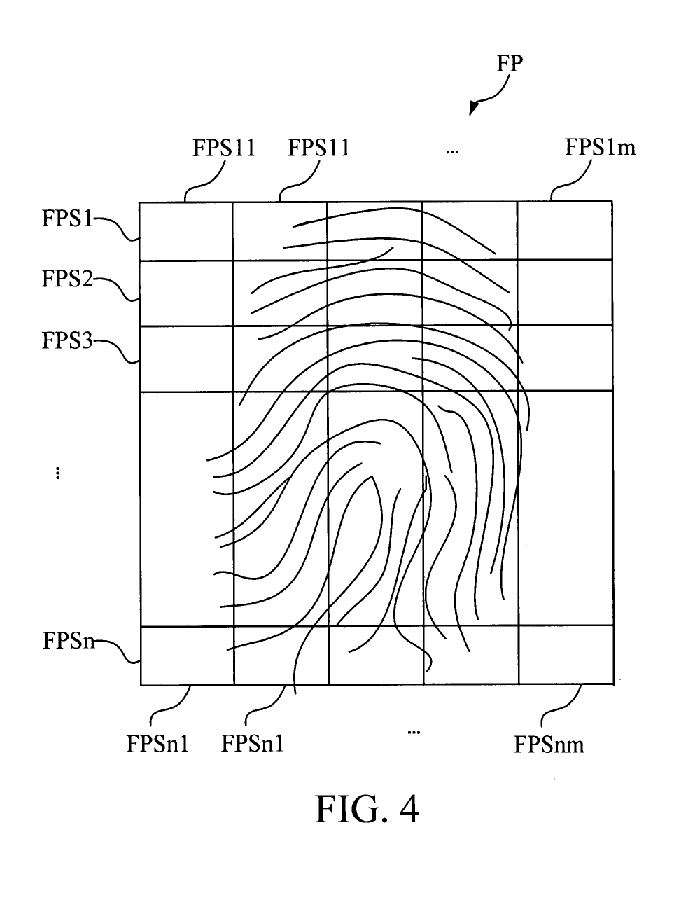

Please refer to FIG. 3 and FIG. 4. FIG. 3 is a functional block diagram of a fingerprint identification system 1′ of another preferred embodiment of the invention. FIG. 4 illustrates the fingerprint FP, related fingerprint image sections FPS1-FPSn, and related fingerprint image sub-sections FPS11-FPSnm. In the embodiment, the fingerprint identification system 1′ includes a communication network 10, a finger-scanning device 12′, and a server 14, as shown in FIG. 3. The finger-scanning device 12′ can optionally be a disk-provided device or a diskless device. Particularly, the finger-scanning device 12′ is different from the finger-scanning device 12 (as shown in FIG. 1) in that the finger-scanning device 12′ further includes a processing module 124. The processing module 124 is used to divide each of the fingerprint image sections FPS1-FPSn generated by the fingerprint sensor 120 to a plurality of fingerprint image sub-sections FPS11-FPSnm. For example, the processing module 124 can divide fingerprint image sections FPS1 into a plurality of fingerprint image sub-sections FPS11-FPS1m, and then, divide fingerprint image sections FPS2 into a plurality of fingerprint image sub-sections FPS21-FPS2m, and so on. The transmitting module 122 is used to transmit the fingerprint image sub-sections FPS11-FPSnm to the server 14 through the communication network 10. The operation principle of the fingerprint identification system 1′ in FIG. 3 is the same as that of the fingerprint identification system 1 in FIG. 1, therefore, discussion of the details will be omitted.

In practice, the transmitting module 122 can encrypt the fingerprint image sub-sections FPS11-FPSnm with a specific encryption, to increase the safety of the transmission of the fingerprint image sub-sections FPS11-FPSnm. Additionally, the size of each of the fingerprint image sub-sections FPS11-FPSnm can be optionally designed by designers, so as to improve the safety in the transmission of the fingerprint image sub-sections FPS11-FPSnm.

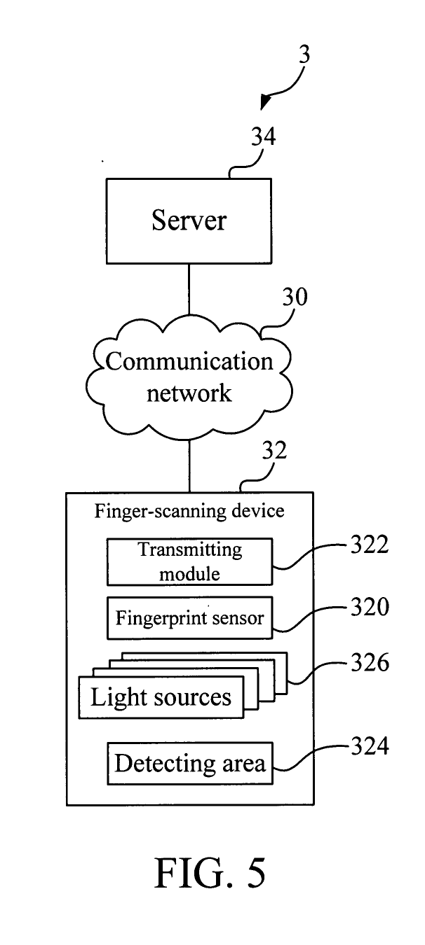

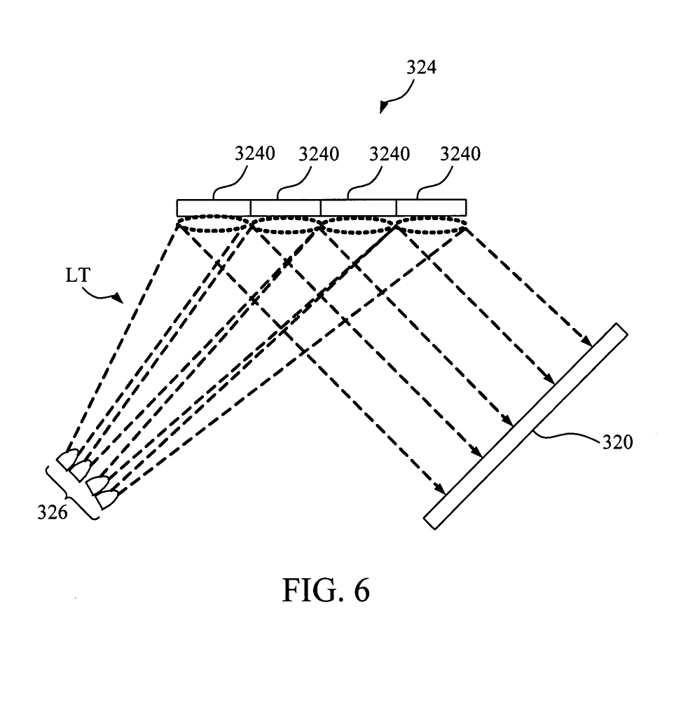

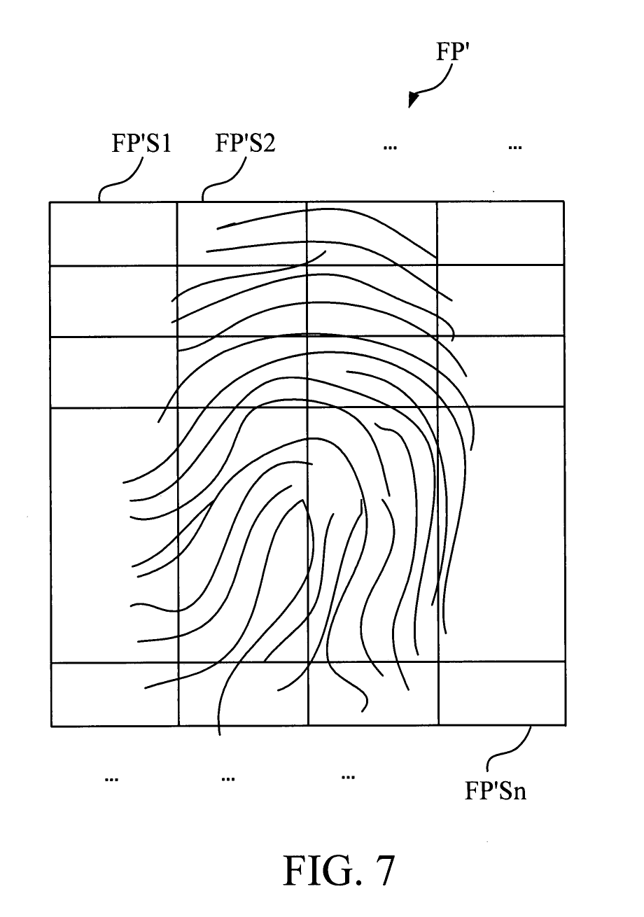

Please refer to FIG. 5 to FIG. 7. FIG. 5 shows a functional block diagram of a fingerprint identification system 3 of another preferred embodiment of the invention. FIG. 6 illustrates the detecting area 324, the light source 326, and the fingerprint sensor 320 in FIG. 5. FIG. 7 illustrates a fingerprint FP′ and related fingerprint image sections FP′S1-FP′Sn. As shown in FIG. 5, the fingerprint identification system 3 includes a communication network 30, a finger-scanning device 32, and a server 34. The finger-scanning device 32 can optionally be a disk-provided device or a diskless device. Furthermore, the finger-scanning device 32 includes a fingerprint sensor 320, a transmitting module 322, a detecting area 324, and a plurality of light sources 326.

As shown in FIG. 6, the detecting area 324 has a plurality of sub-detecting areas 3240. Each of the light sources 326 can emit a light LT to one of the sub-detecting areas 3240. When the fingerprint FP′ passes the detecting area 324, the fingerprint sensor 320 can scan the fingerprint FP′ by the lights LT, so as to generate a plurality of fingerprint image sections FP′S1-FP′Sn corresponding to the sub-detecting areas 3240, as shown in FIG. 7. The transmitting module 322 is used to transmit the fingerprint image sections FP′S1-FP′Sn through the communication network 30. Moreover, the server 34 is used to receive the fingerprint image sections FP′S1-FP′Sn from the communication network 30, reproduce the fingerprint FP′, and further perform identification in accordance with the fingerprint FP′. In practice, the transmitting module 322 can encrypt the fingerprint image sections FP′S1-FP′Sn with a specific encryption, to increase the safety of the transmission of the fingerprint image sections FP′S1-FP′Sn.

In the embodiment, the communication network 30 can be, but not limited to, a local area network, an intranet, an internet, a radio telecommunication network, or a public switched telephone network.

In the embodiment, during the transmission, an interception of part of the fingerprint image sections FP′S1-FP′Sn will not reproduce a complete or identical fingerprint FP′, so that an invader with partial image cannot pass the identification process via the server 34. Therefore, the transmission of data of fingerprint will be safer than before.

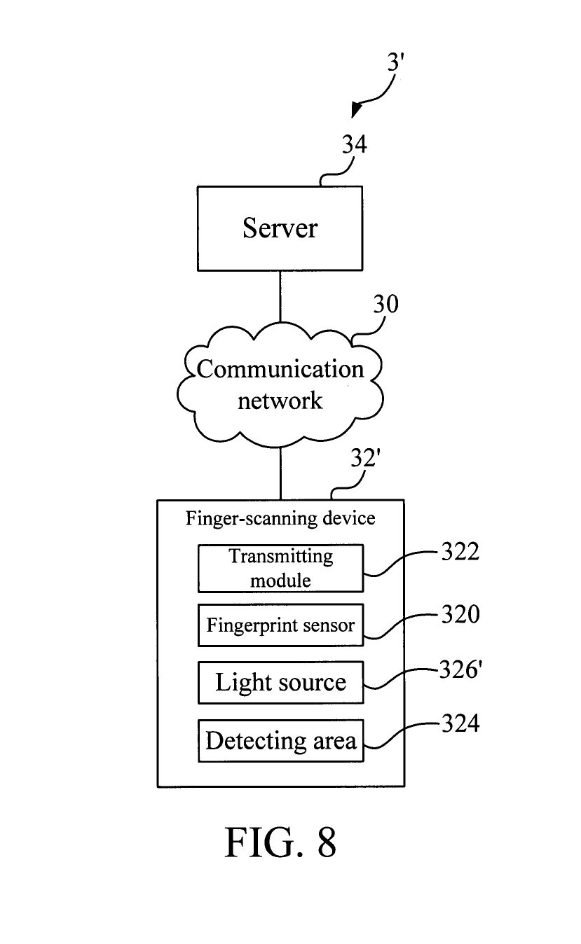

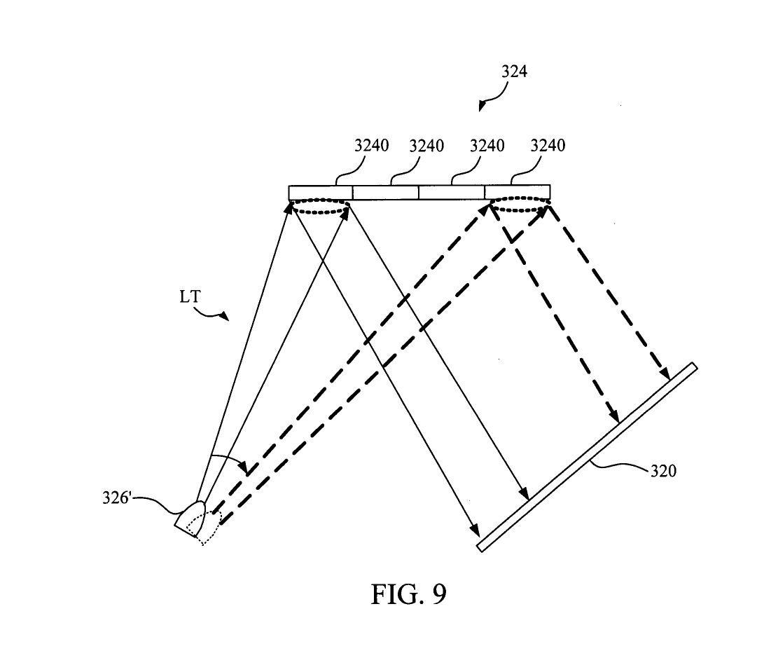

Please refer to FIG. 8 and FIG. 9 together with FIG. 7. FIG. 8 shows a functional block diagram of a fingerprint identification system 3′ of another preferred embodiment of the invention. FIG. 9 illustrates the detecting area 324, the light source 326′, and the fingerprint sensor 320 in FIG. 8. As shown in FIG. 8, the fingerprint identification system 3′ includes a communication network 30, a finger-scanning device 32′, and a server 34. The finger-scanning device 32′ can optionally be a disk-provided device or a diskiess device. The major difference between the current finger-scanning device 32′ and the finger-scanning device 32 (as shown in FIG. 5) is that the current finger-scanning device 32′ includes only a single light source 326′. Moreover, the light source 326′ is rotatably disposed in the finger-scanning device 32′, for emitting a light LT to one of the sub-detecting areas 3240, as shown in FIG. 9. It should be noted that because the light source 326′ is rotatably disposed in the finger-scanning device 32′, it can emit light LT to every sub-detecting area 3240 by rotation. When the fingerprint FP′ passes the detecting area 324, the fingerprint sensor 320 can scan the fingerprint FP′ by the light LT, so as to generate a plurality of fingerprint image sections FP′S1-FP′Sn corresponding to the sub-detecting areas 3240, as shown in FIG. 7. Furthermore, the transmitting module 322 can transmit the fingerprint image sections FP′S1-FP′Sn to the server 34 through the communication network 30. The operation principle of the fingerprint identification system 3′ in FIG. 8 is the same as the fingerprint identification system 3 in FIG. 5, therefore, discussion of details will be omitted.

In practice, the transmitting module 322 can encrypt the fingerprint image sections FP′S1-FP′Sn with a specific encryption to increase the safety in the transmission of the fingerprint image sections FP′S1-FP′Sn.

Compared with the prior art, the fingerprint identification system of the invention can transmit and receive fingerprint image sections via transmitting module, reproduce the fingerprint, and then perform identification in accordance with the fingerprint. Furthermore, during the transmission, an interception of part of the fingerprint image sections will not reproduce a complete or identical fingerprint, so that an invader cannot pass the identification process with the partial fingerprint he gets via the server. Therefore, the transmission of data of fingerprint will be safer than before.

Although the present invention has been illustrated and described with reference to the preferred embodiment thereof, it should be understood that it is in no way limited to the details of such embodiment but is capable of numerous modifications within the scope of the appended claims.

What is claimed is:

1. A fingerprint identification system, comprising:
a communication network;
a finger-scanning device, comprising:
a fingerprint sensor for scanning a fingerprint, so as to generate a plurality of fingerprint image sections; and
a transmitting module for transmitting the fingerprint image sections through the communication network instantly when each of the fingerprint image sections is generated; and
a server for receiving the fingerprint image sections from the communication network, reproducing the fingerprint, and performing identification according to the fingerprint.

2. The fingerprint identification system of claim 1, wherein the communication network is one selected from the group consisting of: a local area network, an intranet, an internet, a radio telecommunication network, and a public switched telephone network.

3. The fingerprint identification system of claim 1, wherein the finger-scanning device is a diskless device.

4. The fingerprint identification system of claim 1, wherein the transmitting module encrypts the fingerprint image sections with an encryption approach before transmitting the fingerprint image sections.

5. A fingerprint identification system, comprising:
a communication network;
a finger-scanning device, comprising:
a fingerprint sensor for scanning a fingerprint, so as to generate a plurality of fingerprint image sections;
a processing module for dividing each of the fingerprint image sections into a plurality of fingerprint image sub-sections; and
a transmitting module for transmitting the fingerprint image sub-sections through the communication network; and
a server for receiving the fingerprint image sub-sections from the communication network, reproducing the fingerprint, and performing identification according to the fingerprint.

6. The fingerprint identification system of claim 5, wherein the communication network is one selected from the group consisting of: a local area network, an intranet, an internet, a radio telecommunication network, and a public switched telephone network.

7. The fingerprint identification system of claim 5, wherein the finger-scanning device is a diskless device.

8. The fingerprint identification system of claim 5, wherein the transmitting module encrypts the fingerprint image sections with an encryption approach before transmitting the fingerprint image sections.

9. A fingerprint identification system, comprising:
a communication network;
a finger-scanning device, comprising:
a detecting area with a plurality of sub-detecting areas;
a plurality of light sources, each of which emitting a light to one of the sub-detecting areas;
a fingerprint sensor for scanning a fingerprint passing the detecting area, so as to generate a plurality of fingerprint image sections corresponding to the plurality of sub-detecting areas; and
a transmitting module for transmitting the fingerprint image sections through the communication network; and
a server for receiving the fingerprint image sections from the communication network, reproducing the fingerprint, and performing identification according to the fingerprint.

10. The fingerprint identification system of claim 9, wherein the communication network is one selected from the group consisting of: a local area network, an intranet, an internet, a radio telecommunication network, and a public switched telephone network.

11. The fingerprint identification system of claim 9, wherein the finger-scanning device is a diskless device.

12. The fingerprint identification system of claim 9, wherein the transmitting module encrypts the fingerprint image sections with an encryption approach before transmitting the fingerprint image sections.

13. A fingerprint identification system, comprising:
a communication network;
a finger-scanning device, comprising:
a detecting area with a plurality of sub-detecting areas;
a light source, rotatably disposed in the finger-scanning device, for emitting a light to one of the sub-detecting areas;
a fingerprint sensor for scanning a fingerprint passing the detecting area, so as to generate a plurality of fingerprint image sections corresponding to the plurality of sub-detecting areas; and
a transmitting module for transmitting the fingerprint image sections through the communication network; and
a server for receiving the fingerprint image sections from the communication network, reproducing the fingerprint, and performing identification according to the fingerprint.

14. The fingerprint identification system of claim 13, wherein the communication network is one selected from the group consisting of: a local area network, an intranet, an internet, a radio telecommunication network, and a public switched telephone network.

15. The fingerprint identification system of claim 13, wherein the finger-scanning device is a diskless device.

16. The fingerprint identification system of claim 13, wherein the transmitting module encrypts the fingerprint image sections with an encryption approach before it transmits the fingerprint image sections.
